(19) United States
(12) Patent Application Publication
(10) Pub. No.: US 2015/0193841 A1
(43) Pub. Date: Jul. 9, 2015

(54) Registration of Customers

(71) Applicant: AUDIENCE, INC., Mountain View, CA (US)

(72) Inventor: Alexis Bernard, Mountain View, CA (US)

(21) Appl. No.: 14/590,440

(22) Filed: Jan. 6, 2015

Related U.S. Application Data
(60) Provisional application No. 61/924,112, filed on Jan. 6, 2014.

(51) Int. Cl. G06Q 30/02; G06Q 30/06

(52) U.S. Cl. CPC G06Q 30/0281; G06Q 30/0641

(57) ABSTRACT

Systems and methods for registration of a customer inside a business place are disclosed. A method can include transmitting, by one or more ultrasound speakers associated with the business place, an ultrasound audio signature to a mobile device associated with a customer. In addition, the method can include sending, over one or more networks, a message from the mobile device to a server. An example message includes at least information associated with the customer and the ultrasound audio signature. In response to the message, a notification concerning the customer is sent from the server to the business place, according to various embodiments.

### CROSS-REFERENCE TO RELATED APPLICATION

The present application claims the benefit of U.S. Provisional Application No. 61/924,112, filed on Jan. 6, 2014. The subject matter of the aforementioned application is incorporated herein by reference for all purposes.

### TECHNICAL FIELD

This disclosure relates generally to systems and methods for automatic registration of customers and, more specifically, the systems and methods for registration of customers at business locations using ultrasound signatures.

### BACKGROUND

Unless otherwise indicated, it should not be assumed that any of the approaches described in this section qualify as prior art merely by virtue of their inclusion in this section.

Automatic registration of customers entering a business place, such as, for example, a department store, a grocery store, a shop, a cafe, or any other place of business providing services to customers may be useful to the customers, as well as to the service providers. For example, a customer of a coffee shop may wish the coffee shop to know that he or she has just entered the shop so that a barista may start preparing the customer's favorite beverage. In another example, a buyer might be interested in automatic check-in when entering a department store or a grocery store so that the buyer is able to immediately receive information about current sales or receive a coupon for some kind of discount on the price of certain types of goods or services, with the information and coupons being sent to the buyer's mobile device such as, for example, a cellular phone.

Some of the known systems of registration of a customer at a business place are based on location determination by the Global Positioning System (GPS) using a cellular phone or other mobile device associated with the customer. The registration based on the GPS location determination is not sufficiently robust, however, since errors in determining GPS coordinates may be too large to establish a precise location of the customer. Additionally, the registration of the customer based on the GPS may be confusing since, although other business places can be located on different floors of the same building above or below the customer's location, the GPS will render substantially the same coordinates for all locations in the building. Moreover, a GPS navigation module will consume significant amounts of the battery power of the mobile device.

Therefore, more robust systems and methods for an automatic registration of customers at business places are needed.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an aspect of the present disclosure, a method for registration of customers inside a business place is provided. An example method includes capturing, by a mobile device associated with a customer, an ultrasound signal. The ultrasound signal is periodically transmitted by at least one loudspeaker associated with a business place. In some embodiments, the ultrasound signal is captured by at least one microphone associated with the mobile device.

The method allows determining, by the mobile device, that the ultrasound signal includes an ultrasound audio signature from a plurality of ultrasound audio signatures. The method may also include sending, by the mobile device, a message in response to the determination. The message may include at least one of the ultrasound audio signature and information associated with the customer.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements and in which:

FIG. 1 is a schematic illustrating a system for registration of a customer inside a business place, according to an example embodiment.

FIG. 2 shows an example mobile device suitable for implementing methods for registration of a customer inside a business place.

FIG. 3 is a flow chart illustrating a method for registration of a customer inside a business place, according to an example embodiment.

FIG. 4 illustrates an example computer system that may be used to implement embodiments of the present disclosure.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed.

Various embodiments of the present technology disclosed herein relates to systems and methods for automatic registration of customers entering a business place providing products and/or services to customers. Other features of the disclosed technology include providing a service that associates a business place interested in automatic registration of customers with a unique ultrasound audio signature that unambiguously identifies the business place to the customer. Various embodiments described herein may be practiced on any mobile device that is configured to receive audio signals and communicate via a wireless network. Such mobile devices include, but not limited to, smartphones, cellular phones, phablets, wearables, personal digital assistants, tablet computers, and the like.

According to various embodiments of the present disclosure, a method for registration of a customer inside a business place includes capturing, by a mobile device associated with a customer, an ultrasound signal. The ultrasound signal can be periodically transmitted by at least one loudspeaker associated with the business place. The method allows for determining, by the mobile device, that the ultrasound signal includes an ultrasound audio signature from a plurality of ultrasound audio signatures. The method includes sending, by the mobile device, a message in response to the determination. The message may include at least one of the ultrasound audio signature and information associated with the customer.

In certain embodiments, each of the plurality of ultrasound audio signatures, which may be stored in a subscribers' database, are sufficiently unique to be recognized without errors and false rejections. The signatures from the plurality of ultrasound audio signatures can be sufficiently short to be quickly recognized by the mobile device. In some embodiments, the ultrasound audio signature includes a binary code.

In some embodiments, an audible range of the ultrasound audio signal is limited by at least one of amplitude of the ultrasound audio signal, walls of rooms of a building (where walls of rooms of a building is understood to mean walls, windows, doors, alcoves, ceilings, and other bounds to a room excluding a floor), and floors of the building.

In some embodiments, the message sent from mobile device is sent via one or more wireless networks and wherein the ultrasound signal is captured by at least one microphone of the mobile device. In certain embodiments, the notification sent from the server to the business place includes at least information associated with the customer.

In yet other embodiments, the message can be sent by the mobile device to a server. The server may be configured to, in response to the message, send a notification to the business place via one or more wireless networks. The notification may include at least information associated with the customer. The server may additionally be communicatively coupled to a subscribers' database. In turn, the subscribers' database includes the plurality of ultrasound audio signatures that correspond to a plurality of business places.

According to some embodiments, the mobile device may receive information from the business. The information may be regarding goods or services associated with the business place. This information associated with goods or services associated with the business place may include a discount on a purchase of the goods or services associated with the business place.

Also provided is a system for registration of customers inside a business place. An example system includes a mobile device. The mobile device associated with and communicatively connected to the server is configured to capture an ultrasound signal. The ultrasound signal is periodically transmitted by at least one loudspeaker associated with the business place. The mobile device is further configured to determine that the ultrasound signal includes an ultrasound audio signature from a plurality of ultrasound audio signatures. The mobile device is configured to send the message in response to the determination. In some embodiments, the message includes at least one of the ultrasound audio signature and information associated with the customer.

In some embodiments, the message may be sent to a server. The server is configured to send a notification to the business place in response to receiving the message. The notification includes at least information related to the customer.

According to another example embodiment of the present disclosure, the steps of the method for registration of customers inside a business place are stored on a machine-readable medium comprising instructions, which when implemented by one or more processors perform the recited steps.

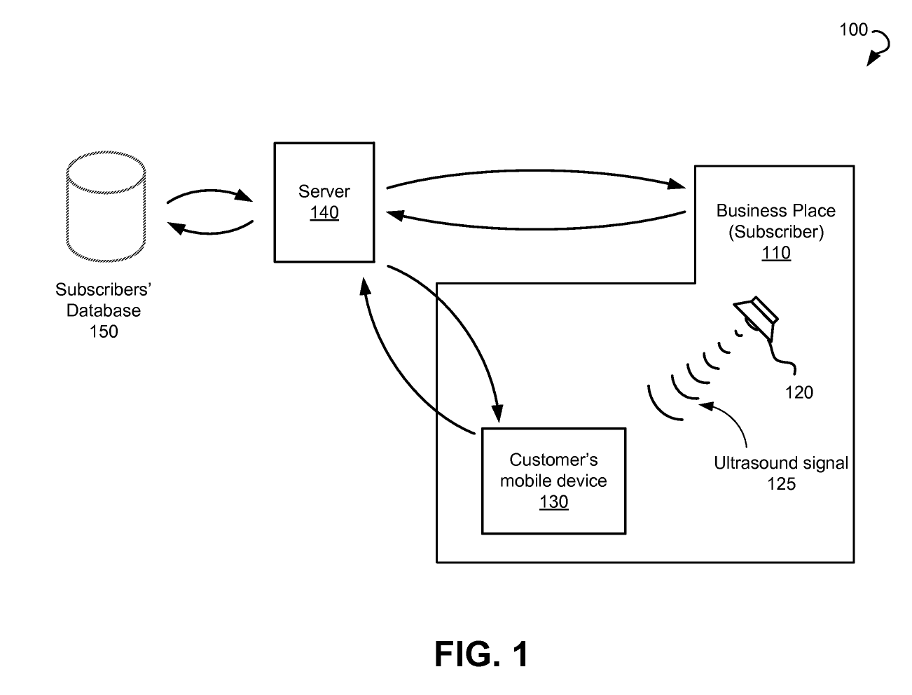

Referring now to the drawings, FIG. 1 shows a system 100 for registration of a customer inside a business place, according to an example embodiment. The system 100 includes one or more loudspeakers 120 located inside the business place 110. The one or more loudspeakers 120 may be configured to produce signals within at least both the audible and ultrasound ranges. The loudspeaker 120 serves as a beacon for periodically transmitting an ultrasound signal 125. The ultrasound signal 125 includes a unique ultrasound audio signature associated with the business place 110. In some embodiments, the signature includes a binary code or Morse code corresponding to a unique identifier associated with the business place 110.

One of the advantages of using the ultrasound signal to transmit a unique ultrasound audio signature includes the inability of ultrasound waves to penetrate walls of a building, so that the ultrasound signal can be associated with a specific building, specific floor of the building, or specific room inside the building. The audible range of the ultrasound signal can be also modified by the amplitude of the signal, so that ultrasound beacons transmitting different ultrasound audio signatures can be placed in different sections of a large room, for example, different sections of a grocery store. Another advantage of using ultrasound signals to transmit ultrasound audio signatures includes the inability of people to hear ultrasound waves. In some embodiments, the loudspeakers 120 are also configured to play a regular audio signal, for example music, speech, and the like. The ultrasound signal 125 can be superimposed on any other speech or music signal (in the normal human hearing range 20 to 20,000 Hz), currently being played by the loudspeakers 120. In some embodiments, the ultrasound signal 125 is in range outside both human and pet hearing.

Once a customer approaches the audible range of the loudspeaker 120 inside the business place 110, the ultrasound signal 125 can be detected by a mobile device 130 associated with the customer. In some embodiments, the mobile device 130 includes at least one sensor (for example, a microphone) operable to continuously listen for ultrasound signals. In some embodiments, a microphone associated with the mobile device 130 could be operable to detect both voice and ultrasound signals. In some embodiments, the mobile device 130 can include a chip operable to recognize an ultrasound audio signature. Alternatively, in some embodiments, processing for recognition of the ultrasound audio signature is performed remotely on a server 140. In some embodiments, processing for recognition of the ultrasound audio signature is performed in cloud-based computing resource(s), also referred to as the computing cloud. The cloud-based computing resource includes computing resources (hardware and software) available at a remote location and accessible over a network (for example, the Internet). The cloud-based computing resources can be shared by multiple users and can be dynamically re-allocated based on demand. In some embodiments, the cloud-based computing resource(s) includes one or more server farms/clusters, including a collection of computer servers that can be co-located with network switches and/or routers. In various embodiments, the mobile device 130 can be connected to the server 140 or computing cloud via one or more wireless network(s). The mobile device 130 is operable to send data, including ultrasound audio signatures (in a digital from) to server 140 for further processing.

In some embodiments, once the ultrasound signal 125 has been detected by the mobile device 130, a message can be sent from the mobile device 130 to a server 140 via a network, e.g., via a cellular or Wi-Fi network using the Short Message Service (SMS) or an Internet protocol. In certain embodiments, the message includes at least an ultrasound audio signature associated with the business place 110 in a pre-determined format. In various embodiments, the server 140 is connected to a subscribers' database 150 containing ultrasound audio signatures of business places (including the business place 110) subscribed to the automatic customer registration service. The server 140 is operable to look up the received ultrasound audio signature in database 150 to identify the business place 110 and can send a message to the business place 110 via a wired or wireless network. The message can contain customer related information, e.g. the customer phone number, so that the business place 110 can be notified that the customer associated with the phone number has entered the business place 110.

The ultrasound audio signatures stored in the subscriber database are sufficiently unique to be recognized without errors and false rejections. The ultrasound audio signatures are also sufficiently short to be quickly recognized by a chip or software installed on the mobile device 130, or via the computing cloud. Therefore, even though a large number of unique ultrasound audio signatures can be used by business locations around the world, the number of the unique ultrasound audio signatures is still limited. In some embodiments, the unique ultrasound audio signatures are generated in advance and offered for sale to subscribers.

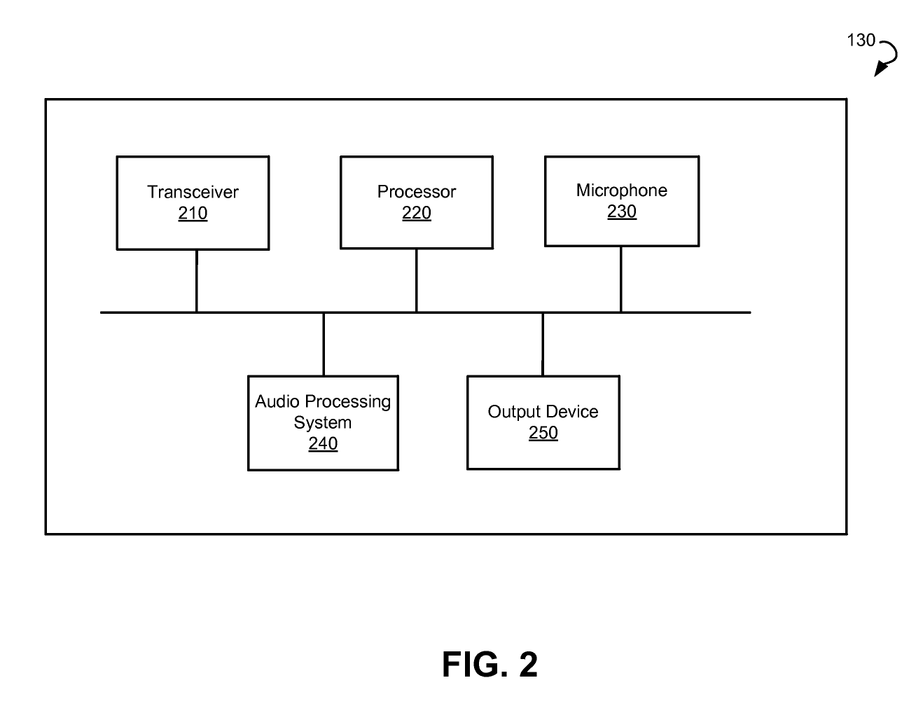

FIG. 2 shows a mobile device 130 suitable for implementing a method for registration of a customer inside a business place, according to various example embodiments. The example mobile device 130 includes a transceiver 210, a processor 220, a microphone 230, an audio processing system 240, and an output device 250. In other embodiments, the mobile device 130 includes additional or different components to provide a particular operation or functionality. Similarly, the mobile device 130 may comprise fewer components that perform similar or equivalent functions to those depicted in FIG. 2.

In some embodiments, the transceiver 210 is configured to communicate with a network such as the Internet, Wide Area Network (WAN), Local Area Network (LAN), cellular network, and so forth, to receive and transmit the data stream.

In some embodiments, the processor 220 includes hardware and software that implement the processing of data and various other operations depending on a type of the mobile device 130. A memory (e.g., non-transitory computer readable storage medium) is operable to store, at least in part, instructions and data for execution by processor 220, including recognition of an ultrasound audio signature.

The audio processing system 240 may include hardware and software that implement processing an acoustic signal, according to various embodiments disclosed herein. The audio processing system 240 is further configured to receive acoustic signals from an acoustic source via at least one microphone 230 (which may be one or more microphones or acoustic sensors) and process the acoustic signals. After reception by the microphone 230, the acoustic signals may be converted into electric signals by an analog-to-digital converter. In various embodiments, the microphones 230 are suitably designed, modified, and/or originally constructed to support the higher frequency response of ultrasound signal(s) additionally to regular human range acoustic signals.

The output device 250 is any device that provides an audio output to a listener. For example, the output device 250 may comprise a speaker, a class-D output, an earpiece of a headset, a display, or a handset on the mobile device 130.

In certain embodiments, a chip is integrated in the mobile device 130. The chip is specially designed to listen for ultrasound signals of pre-determined forms and waves and recognize the ultrasound audio signatures.

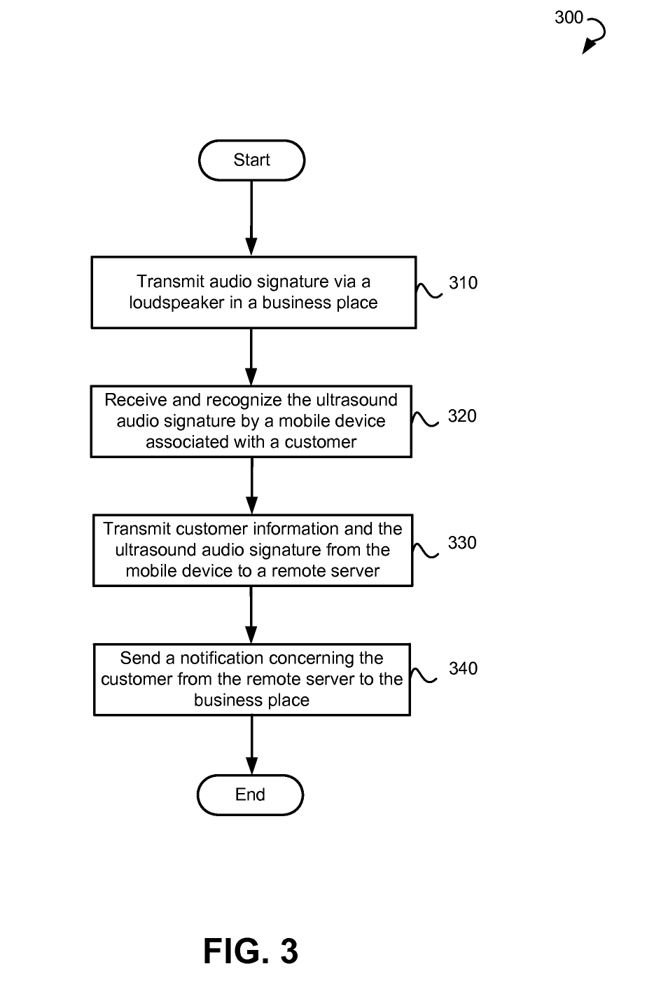

FIG. 3 is a flow chart illustrating a method 300 for registration of a customer inside a business place, according to an example embodiment. The steps of the method 300 can be performed using components of system 100 described with reference to FIG. 1 above. At block 310, the method 300 includes transmitting an ultrasound audio signature by a loudspeaker located inside a business place. At block 320, the ultrasound audio signature is received and recognized by a mobile device associated with a customer. At block 330, the ultrasound audio signature and customer information is transmitted from the mobile device to a remote device, such as a remote server. At block 340, a notification concerning the customer can be sent from the remote server to the business place.

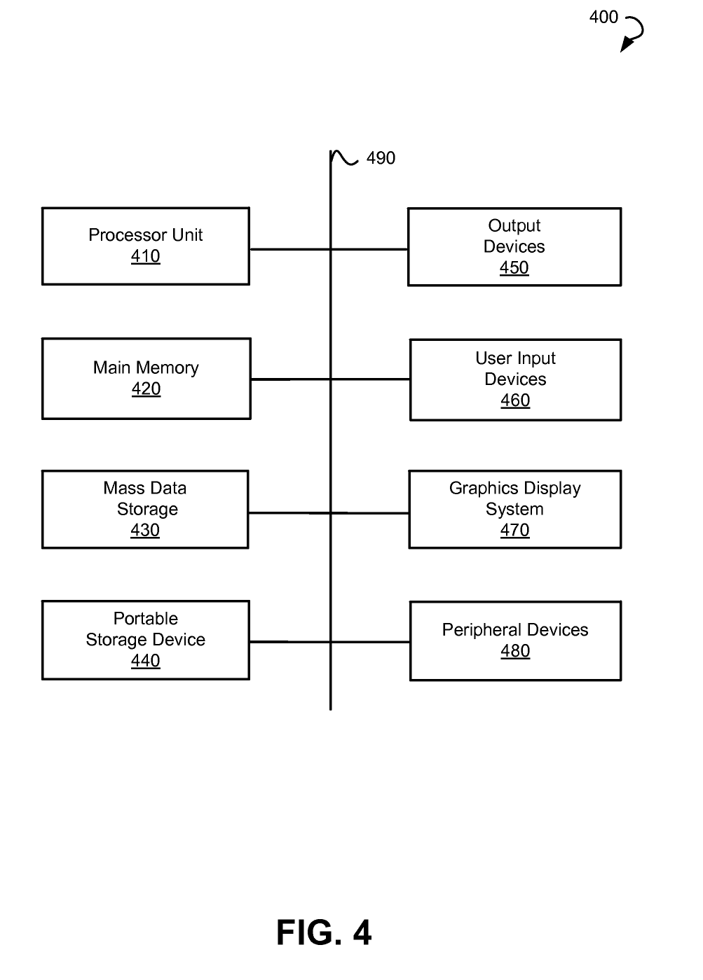

FIG. 4 illustrates an exemplary computer system 400 that may be used to implement some embodiments of the present invention. The computer system 400 of FIG. 4 may be implemented in the contexts of the likes of computing systems, networks, servers, or combinations thereof. The computer system 400 of FIG. 4 includes one or more processor units 410 and main memory 420. Main memory 420 stores, in part, instructions and data for execution by processor units 410. Main memory 420 stores executable code when in operation, in this example. The computer system 400 of FIG. 4 further includes a mass data storage 430, portable storage device 440, output devices 450, user input devices 460, a graphics display system 470, and peripheral devices 480.

The components shown in FIG. 4 are depicted as being connected via a single bus 490. The components may be connected through one or more data transport means. Processor unit 410 and main memory 420 are connected via a local microprocessor bus, and the mass data storage 430, peripheral device(s) 480, portable storage device 440, and graphics display system 470 are connected via one or more input/output (I/O) buses.

Mass data storage 430, which can be implemented with a magnetic disk drive, solid state drive, or an optical disk drive, is a non-volatile storage device for storing data and instructions for use by processor unit 410. Mass data storage 430 stores the system software for implementing embodiments of the present disclosure for purposes of loading that software into main memory 420.

Portable storage device 440 operates in conjunction with a portable non-volatile storage medium, such as a flash drive, floppy disk, compact disk, digital video disc, or Universal Serial Bus (USB) storage device, to input and output data and code to and from the computer system 400 of FIG. 4. The system software for implementing embodiments of the present disclosure can be stored on such a portable medium and input to the computer system 400 via the portable storage device 440.

User input devices 460 can provide a portion of a user interface. User input devices 460 may include one or more microphones, an alphanumeric keypad, such as a keyboard, for inputting alphanumeric and other information, or a pointing device, such as a mouse, a trackball, stylus, or cursor direction keys. User input devices 460 can also include a touchscreen. Additionally, the computer system 400, as shown in FIG. 4, includes output devices 450. Suitable output devices 450 include speakers, printers, network interfaces, and monitors.

Graphics display system 470 includes a liquid crystal display (LCD) or other suitable display device. Graphics display system 470 is configurable to receive textual and graphical information and processes the information for output to the display device.

Peripheral devices 480 may include any type of computer support device to add additional functionality to the computer system.

The components provided in the computer system 400 of FIG. 4 are those typically found in computer systems that may be suitable for use with embodiments of the present disclosure and are intended to represent a broad category of such computer components that are well known in the art. Thus, the computer system 400 of FIG. 4 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 400 is implemented as a cloud-based computing environment, such as a virtual machine operating within a computing cloud. In other embodiments, the computer system 400 may itself include a cloud-based computing environment, where the functionalities of the computer system 400 are executed in a distributed fashion. Thus, the computer system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computer system 400, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for registration of a customer inside a business place, the method comprising:
capturing, by a mobile device associated with a customer, an ultrasound signal, the ultrasound signal being periodically transmitted by at least one loudspeaker associated with the business place;
determining, by the mobile device, that the ultrasound signal includes an ultrasound audio signature from a plurality of ultrasound audio signatures; and
responsive to the determination, sending, by the mobile device, a message, the message including at least one of the ultrasound audio signature and information associated with the customer.

2. The method of claim 1, wherein each of the plurality of ultrasound audio signatures is sufficiently unique to be recognized without errors and false rejections and is sufficiently short to be recognized by the mobile device.

3. The method of claim 1, wherein the ultrasound audio signature includes a binary code.

4. The method of claim 1, wherein an audible range of the ultrasound signal is limited by at least one of amplitude of the ultrasound signal, walls of rooms of a building, and floors of the building.

5. The method of claim 1, wherein the message is sent via one or more wireless networks and wherein the ultrasound signal is captured by at least one microphone associated with the mobile device.

6. The method of claim 1, further comprising receiving information, by the mobile device, from the business place, the information being regarding goods or services associated with the business place.

7. The method of claim 6, wherein the information received by the mobile device from the business place includes a discount on purchase of the goods or services associated with the business place.

8. The method of claim 1, wherein the message comprises information associated with the customer.

9. The method of claim 1, wherein the message is sent by the mobile device to a server, the server being configured to, responsive to the message, send a notification to the business place via one or more wireless networks, the notification including at least information associated with the customer.

10. The method of claim 9, the server being communicatively coupled to a subscribers' database, the subscribers' database including the plurality of ultrasound audio signatures corresponding to a plurality of business places.

11. A system for registration of a customer inside a business place, the system comprising:
a mobile device associated with a customer, the mobile device being configured to:
capture an ultrasound signal, the ultrasound signal being periodically transmitted by at least one loudspeaker associated with the business place;
determine that the ultrasound signal includes an ultrasound audio signature from a plurality of ultrasound audio signatures; and
responsive to the determination, send a message via one or more wireless networks, the message including at least one of the ultrasound audio signature and information associated with the customer.

12. The system of claim 11, wherein each of the plurality of ultrasound audio signatures is sufficiently unique to be recognized without errors and false rejections.

13. The system of claim 11, wherein each of the plurality of ultrasound audio signatures includes binary code and is sufficiently short to be recognized by the mobile device.

14. The system of claim 11, wherein an audible range of the ultrasound signal is limited by at least one of the following: amplitude of the ultrasound audio signal, walls of rooms of a building, and floors of the building.

15. The system of claim 11, wherein the mobile device is further configured to receive information from the business place, the information being regarding goods or services associated with the business place.

16. The system of claim 15, wherein the information includes a discount on purchase of the goods or services associated with the business place.

17. The system of claim 11, wherein the message comprises information associated with the customer.

18. The system of claim 11, further comprising a server, wherein the message is sent by the mobile device to the server, the server being configured to, responsive to the message, send a notification to the business place via one or more wireless networks, the notification including at least information associated with the customer.

19. The system of claim 18, wherein the server is communicatively connected to a subscribers' database, the subscribers' database including the plurality of ultrasound audio signatures corresponding to a plurality of business places.

20. A non-transitory processor-readable medium having embodied thereon a program being executable by at least one processor to perform steps of a method, the method comprising:
capturing, by a mobile device associated with a customer, an ultrasound signal, the ultrasound signal being periodically transmitted by at least one loudspeaker associated with the business place;
determining, by the mobile device, that the ultrasound signal includes an ultrasound audio signature from a plurality of ultrasound audio signatures; and
responsive to the determination, sending, by the mobile device, a message via one or more wireless networks, the message including at least one of the ultrasound audio signature and information associated with the customer;
the mobile device being configured to send the message to a server, the server being configured to, responsive to the message, send a notification to the business place, the notification including at least information associated with the customer.
